(19) United States
(12) Patent Application Publication
(10) Pub. No.: US 2009/0189912 A1
(43) Pub. Date: Jul. 30, 2009

(54) ANIMATION JUDDER COMPENSATION

(75) Inventor: Koen Johanna Guillaume Holtman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,045

(22) PCT Filed: Oct. 11, 2005
(86) PCT No.: PCT/IB05/53337

§ 371 Date: Apr. 11, 2007

(30) Foreign Application Priority Data
Oct. 19, 2004 (EP) 04105158.2

(51) Int. Cl. G09G 5/00; G09G 5/36

(52) U.S. Cl. 345/606; 345/545

(57) ABSTRACT

Conventional concepts of signal processing have no specifically adapted judder compensation for combined streams of fields from graphics and further image signals and therefore show animation judder artifacts. Presently judder compensation is adapted for further image signals like a video only, and motion blur in a video image signal often hides judder artifacts. However, this is not the case for graphics objects like bitmaps. At an increased reference refresh rate (60 fps) the inventive concept provides a combined stream (11) of fields of the further (3) and the graphics (7A, 7B) image signals, in particular comprising animations (35). By interpolating (18A, 18B) between the image fields of the graphics image signal (7A, 7B) already upon creating the graphics image signal (7A, 7B), the input refresh rate (24 fps) of a graphics image signal (7A, 7B) is raised to the reference refresh rate (60 fps) before the combining step (23). A fairly simple interpolation method and developed configurations thereof achieve a high-quality output on a display (25), better than that of sophisticated state of the art systems.

### FIELD OF THE INVENTION

The present invention relates to an image signal processing method for providing a combined stream of image fields from a graphics image signal and a further image signal. The invention also relates to a respective image signal processing device and apparatus for image signal processing, a computer program product, and a computing and/or storage device.

In a film source such as a movie, the image signal is usually provided at a refresh rate of 24 image frames per second. At first sight such a film or movie image signal could be converted at the same refresh rate into a video image signal or a similar or another kind of image signal which is referred to as the further image signal. It becomes necessary, however, to raise the initial film refresh rate in order to achieve standard refresh rates of commonly known video standards like PAL video (25 frames per second) or NTSC (29.97 frames per second) or SMPTE (30 frames per second). An example of such a screen is the interlaced high definition or standard definition TV screen. Also most modern computer monitors or other screens are non-interlaced and have an update rate at a frequency higher than 24 frames per second. Therefore, in general a problem of refresh rate mismatch arises, i.e. in general the problem is to provide an output with high quality on a screen that has an update rate higher than the refresh rate of the initial refresh rate of the film or video.

### BACKGROUND OF THE INVENTION

In the prior art several solutions are known for converting a film or movie image signal into a video image signal and thereby overcoming the above-mentioned problem of refresh rate mismatch. A frame is usually converted into two fields as part of such solutions. A field denotes each of the number of pictures or images of an image signal which may consist of originals, duplicates, or interpolations of original frames of a film. A rate of fields is denoted as fields per second (fps) in the following.

Contemporary conversion schemes are known from film scanning systems, like the one of a frame converter as disclosed in U.S. Pat. No. 5,260,787 for converting film frame images into video field images and vice versa. Such a conversion process inherently produces a temporal artifact known as “judder”, which is associated with moving images when the image is sampled at a first field or frame rate and converted into a second, different field or frame rate, e.g. the update rate of a display. As a result, motion vectors in the display may appear with continuously varying velocities. The subjective effect of a judder artifact becomes even more obvious when the frame or field refresh rate conversion is made by simple deletions or repetitions of selected frames or fields.

GB 22 49 907 addresses the problem of judder compensation, disclosing a method of converting specifically an input of 24 frames per second progressive scan format digital video signal into an output of 30 frames per second progressive scan format digital video signal. The output frames are formed from the input frames such that at least four out of every five output frames are produced by motion-compensated interpolation between successive pairs of the input frames. Interpolation schemes in a frame converter of the disclosed kind or other predictive algorithms in a frame converter are capable of making judder artifacts less obvious, but cannot prevent them reliably.

EP 1 215 900 discloses a conversion method, referred to as a telecine display method, comprising a 2:3 (or 3:2) pull-down processing and an interlaced progressive processing which is applied to a telecine digital video signal. The 2:3 pull-down processing is in synchronization with a first timing signal based on an original picture refresh rate. Further processing is in synchronization with a second timing signal based on a telecine digital video signal. A video signal presented to a PDP (Plasma Display Panel) is to maintain the refresh rate of the original picture image of the film source here. Such a synchronization process may help to reduce, but cannot in any case prevent a judder artifact.

This is particular the case with regard to contemporary multimedia applications and multimedia systems in technical fields like consumer and information electronics, digital consumer equipment, audio/video information and entertainment products, and all kinds of audio and video frontends, e.g. MP4-net, Softworks, Crypto or STB. This is because usually different kinds of image signals, in particular a graphics image signal and a further image signal, are joined together in a combined stream. Preferably, a single linear multiplexed stream is installed, e.g. on an optical storage device or an optical playback device.

The graphics image signal may comprise animations which are to be understood as any kind of movable graphics object, mostly in the form of a compressed bitmap such as a picture or a menu or a submenu, that is moved onto a screen. An addition of a graphics image signal, like moving animations, to the further image signal, like a video, results in a combined stream of a graphics image signal and a further image signal which is subject to a new problem denoted “animation judder”. Animation judder arises when the further image signal is provided at the further refresh rate and the graphics image signal is provided at the graphics refresh rate, and the signals have to be combined into a stream of image fields at a higher refresh rate.

The above-mentioned prior art measures, for example 2:3 pull-down processing or motion compensated interpolation between frames, which may be any kind of interpolation algorithm for removing judder artifacts, are applied to the conversion processing of already combined image fields of different kinds. This is not very effective in removing the problem of animation judder. Instead, the judder artifacts are often noticeably larger because there are at least two processing lines of different quality—one graphics processing line and one further processing line. Firstly, a motion blur in an original film or initial video material frequently hides a judder artifact to some extent already. However, in 3:2 pull-down or natural motion compensated frame interpolation processed image fields of a graphics image signal, for example bitmaps, there is no motion blur in the source material to partially hide a judder artifact. Secondly, in the prior art described above the motion compensated frame interpolation or 3:2 pull-down or equivalent processing is tuned to a video image signal and thus neglects the specific demands of a graphics image signal. Parallel processing of a graphics and further image signal or the problem of animation judder is neither addressed nor solved.

Desirable is a concept wherein judder artifacts are reliably compensated even in the case of a combined graphics image signal and further image signal, such that a high quality output on a display having an update rate higher than the refresh rate of a graphics and/or a image signals is achieved.

### SUMMARY OF THE INVENTION

This is where the invention comes in, the object of which is to provide an image signal processing method and an image signal processing device for providing a combined stream of image fields from a graphics image signal and a further image signal, for example a video image signal, and a respective apparatus, a computer program product, and a computer and/or storage device, which effectively and reliably prevent judder artifacts, in particular animation judder artifacts.

As regards the method, the object is achieved by an image signal processing method for providing a combined stream of image fields from a graphics image signal and a further image signal, the method comprising the steps of:

providing image fields of the graphics image signal at a graphics refresh rate in at least one graphics processing line;

providing image fields of the further image signal at a further refresh rate in at least one further processing line;

raising the graphics refresh rate to a reference refresh rate by interpolating between the image fields of the graphics image signal;

combining the further image signal and the graphics image signal into a combined stream of image fields.

The processing method defined above may be also referred to as an animation judder compensated graphics and further image signal processing method. At least one graphics processing line and at least one further processing line are used. A further image signal may comprise any kind of video or audio/video image signal, like a film or a movie. A graphics image signal may comprise any kind of graphics objects, animation graphics, menus, or submenus. The signals are preferably provided as digital signals, e.g. signals from sources that are digital in nature such as an mpeg-2 video decoder. The combining step may comprise a multiplexing step wherein the combined stream is provided as a single multiplexed stream of image fields from the video and graphics image signal. Interpolating may in general be regarded as any kind of filling in missing points between two or more known points on a curve. In principle, interpolation can be performed on a pixel by pixel basis in a graphics content, but in the present case interpolation is preferably performed between the image fields of a graphics image signal on an object by object basis. Any kind of preferable and/or simple interpolation method may be applied to the graphics image signal.

According to the main concept of the invention, firstly the graphics refresh rate is raised already before a combining step into a reference refresh rate, which is advantageously a predetermined update rate of a display means. This means that the combining step is performed on a graphics image signal having a graphics refresh rate which already is at a reference refresh rate higher than the refresh rate of an input image signal. Secondly, raising the graphics refresh rate to the reference refresh rate is achieved by interpolating between the image fields of the graphics image signal. So interpolation is performed in the graphics part of the processing already, and thereafter image fields of the graphics image signal can be further processed on the basis of a raised reference refresh rate before the combining step.

A major, surprising advantage of this easy to apply concept is that a remarkably better judder compensation, in particular animation judder compensation, is achieved compared with rather sophisticated state of the art systems, wherein measures for judder compensation are applied only to a video image signal or only to a final stream of image fields (like e.g. in GB 22 49 907). A variety of further advantages are achieved by the main concept, which are directly apparent from developed configurations of the invention and are further outlined in the dependent method claims.

In a particularly preferred developed configuration of the invention, the image signal processing method is designed for providing a combined stream of image fields from a video image signal and a graphics image signal, the method comprising the steps of:

providing image fields of a graphics image signal at a graphics refresh rate in at least one graphics processing line;

providing image fields of a video image signal at a video refresh rate in at least one video processing line;

raising the graphics refresh rate to the reference refresh rate by interpolating between the image fields of the graphics image signal before a combining step;

combining the video image signal and the graphics image signal into a combined stream of image fields at a predetermined reference refresh rate higher than an input refresh rate of the graphics image signal and/or video image signal.

Thus the inventive concept is advantageously adapted for providing a combined stream of image fields from video image and graphics image signals, wherein the further image signal is formed by a video image signal, the further refresh rate is formed by a video refresh rate, and the further processing line is formed by a video processing line.

The processing method may be applied in particular to any kind of video and/or graphics signals comprising one video processing line and two graphics processing lines.

The image signal processing method and developed configurations thereof may be implemented by a device comprising digital circuits of any preferred kind, whereby the advantages associated with digital circuits may be obtained. A signal processor or other unit or module may fulfill the functions of several means recited in the claims or outlined in the description or shown in the figures. With regard to the device, the invention also leads to an image signal processing device for providing a combined stream of image fields from a graphics image signal and a further image signal, the device comprising:

at least one graphics processing line for providing image fields of a graphics image signal at a graphics refresh rate;

at least one further processing line for providing image fields of a further image signal at a further refresh rate;

a combining module for combining the further image signal and the graphics image signal into a combined stream of image fields, and

a drawing module in the at least one graphics processing line comprising interpolation means for interpolating between the image fields of the graphics image signal so as to raise the graphics refresh rate to a reference refresh rate before the combining module.

The concept of the present invention may also be flexibly adapted in accordance with developed configurations of the image signal processing device, which are further outlined in the dependent device claims.

The invention also leads to an apparatus for image signal processing comprising an image signal processing device as described above, an image storage device and/or a display means.

The invention also leads to a computer program product storable on a medium readable by a computing device comprising a software code section which induces the computing device to execute the method as described above when the product is executed on the computing device.

The invention also leads to a computing and/or storage device, in particular optical storage or optical systems, for executing and/or storing the computer program product.

These and other aspects of the invention will be apparent from and elucidated with reference to the preferred embodiments described hereinafter. It is, of course, not possible to describe every conceivable configuration of the components or methodologies in the description of the present invention, but one of ordinary skill in the art will recognize that many further combinations and permutations of the present inventions are possible. Specifically the techniques described above apply for animation judder compensation for a next-generation graphics and further image signal format. Whereas the invention has particular utility for and will be described as associated with a next-generation movie and graphics format, like the Blu-ray format, it should be understood that the concept of the invention is also operable with other forms of a movie, graphics, or a video format for outputting a combined, in particular multiplexed, stream of image fields from a graphics and a further image signal. For example, the concept of the invention may in principle be applied to all existing audio/video reproduction systems using animations, like DVD, MHP, DVB-ST or DVB subtitles or applications known as Java graphics or SMIL or Flash.

### BRIEF DESCRIPTION OF THE DRAWINGS

For a more complete understanding of the invention, reference should be made to the accompanying drawing wherein:

FIG. 1 is a flowchart of a preferred embodiment of an image signal processing method or device for providing a combined stream of image fields with one video processing line and two graphics processing lines;

FIG. 2 is a drawing demonstrating animation graphics in a movie graphics system of a preferred embodiment;

FIG. 3 is a Table showing the interpolating step for a 24 frames per second progressive video on a disc and a 60 fps interlaced screen at the output in a preferred embodiment;

FIG. 4 is a schematic diagram of a drawing module and an operating principle thereof, for raising the graphics refresh rate to a reference refresh rate before the combining step in a preferred embodiment of an image signal processing device of FIG. 1;

FIG. 5 is a schematic diagram demonstrating the operating principle of a 3:2 pull-down processing module for raising the video refresh rate to a reference refresh rate before the combining step in a preferred embodiment of an image signal processing device of FIG. 1;

FIG. 6 is a sequence of images demonstrating the method of alpha-blending in a combining step in a preferred embodiment;

FIG. 7 is a flowchart of a prescription of an image signal processing method or device according to a next-generation movie graphics system standard;

FIG. 8 is a flowchart of an implementation of an image signal processing method or device that implements the prescription of the next-generation movie graphics system standard of FIG. 7.

### DESCRIPTION OF A NEXT-GENERATION MOVIE GRAPHICS SYSTEM

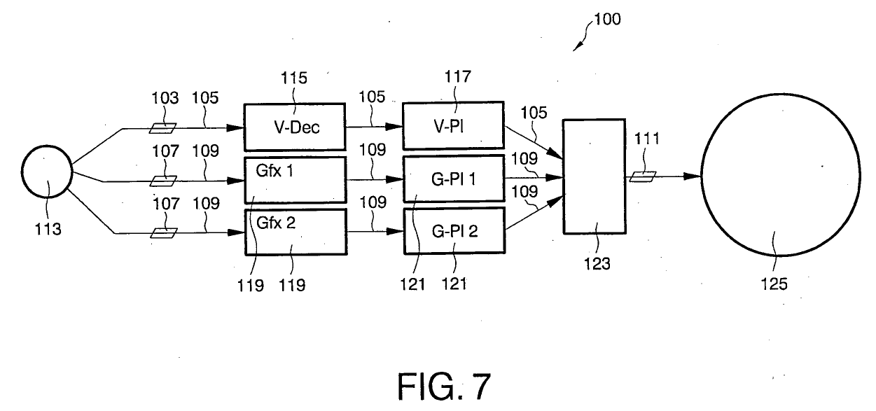

With reference to FIG. 7, a brief description of an exemplary next-generation movie graphics system standard is first given, which system will be referred to as the next-generation system below.

The exemplary next-generation movie graphics system is more elaborate than other existing audio/video reproduction systems using animations like the DVD (Digital Video Disc), MHP, or DVB-ST graphics system. This is because the next-generation system has a better support for graphics image signals, in particular animations, with comparatively smooth motion. The next-generation system prescribes a particular image signal processing method 100 for providing a combined stream of image fields from a graphics image signal and a further image signal, which is a video image signal in this embodiment.

According to the next-generation system such a method 100 comprises the steps of:

providing image fields of a graphics image signal 107 at a graphics refresh rate in at least one graphics processing line 109;

providing image fields of a further, here video, image signal 103 at a video refresh rate in at least one video processing line 105;

combining the video image signal 103 and the graphics image signal 107 into a combined stream 111 of image fields.

The video image signal 103 and graphics image signal 107 are usually taken from a source 113, e.g. a storage device. As a particular specification of the next-generation movie graphics system, one video processing line 105 is provided and two graphics processing lines 109 are provided. The video image signal 103 is provided to a video decoder (V-Dec) 115, which further processes the video image signal 103 and provides the video image signal through a video processing line to a video plane (V-P1) 117. The graphics image signal 107 is further processed by a drawing module 119 (Gfx1, Gfx2) which provides the graphics image signal 107 through a graphics processing line 109 to a graphics plane (G-P11, G-P12) 121.

A combining module 123 is used for combining the video image signal 103 and the graphics image signal 107 into a combined stream 111 of image fields. The stream 111 of image fields is provided as an output to an output device, e.g. in form of a display means 125.

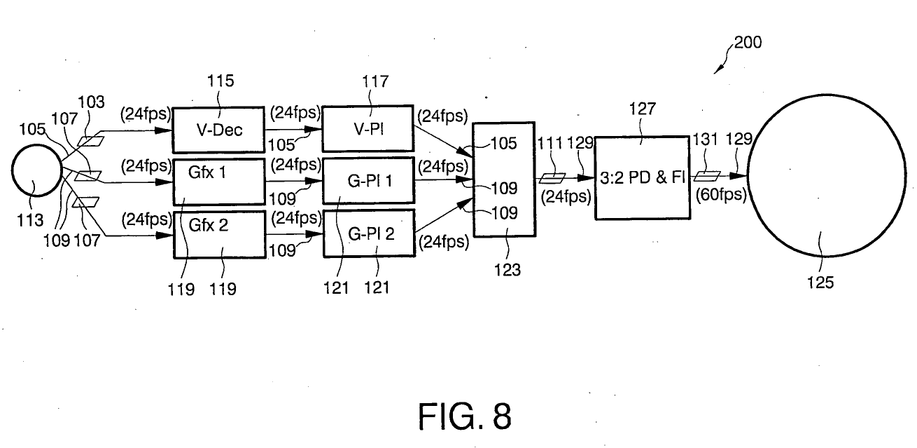

The next-generation movie graphics system standard itself does not specify a single fixed refresh rate of image fields for any of the video image signal 103, graphics image signals 107, or stream 111. Neither does the next-generation system specify a relation between the refresh rates of the input signals and the refresh rate of the output signal produced by the processing chain. The author of the content stored on the source 113 can specify the input rates. The output rates may be predetermined by the capabilities of the connected output device. Advantageously, a video image signal 103 on a source 113 is 24 fields per second (fps) progressive video material. In addition, graphics image signals 107 and in particular animations are also provided at a maximum refresh rate of 24 fps. Respective refresh rates in an implementation of the next-generation movie graphics system standard, with particular inputs and outputs, are indicated in FIG. 8. FIG. 8 shows a flowchart of an implementation of an image signal processing method or device 200 in a next-generation system, where a 3:2 pull-down processing (PD) and/or motion compensated frame interpolation (FI) processing is applied to the combined stream behind a combining step. Features having the same functions and meanings as in FIG. 7 are denoted with the same reference marks in FIG. 8. A specific example of a progressive video image signal 103 and a graphics image signal 107 is given to illustrate the animation judder problem for the case of a 24 fps refresh rate on the source 113 against an update rate of 60 fps (30 frames per second) of a display means 125, e.g. an interlaced high definition or standard definition TV screen. To raise the refresh rate of 24 fps of the stream 111 of image fields to the update rate of 60 fps of the display means 125, a 3:2 pull-down (PD) and/or motion compensated frame interpolation (FI) processing module 127 is implemented behind the combining module 123 in the output line 129 before the display means 125.

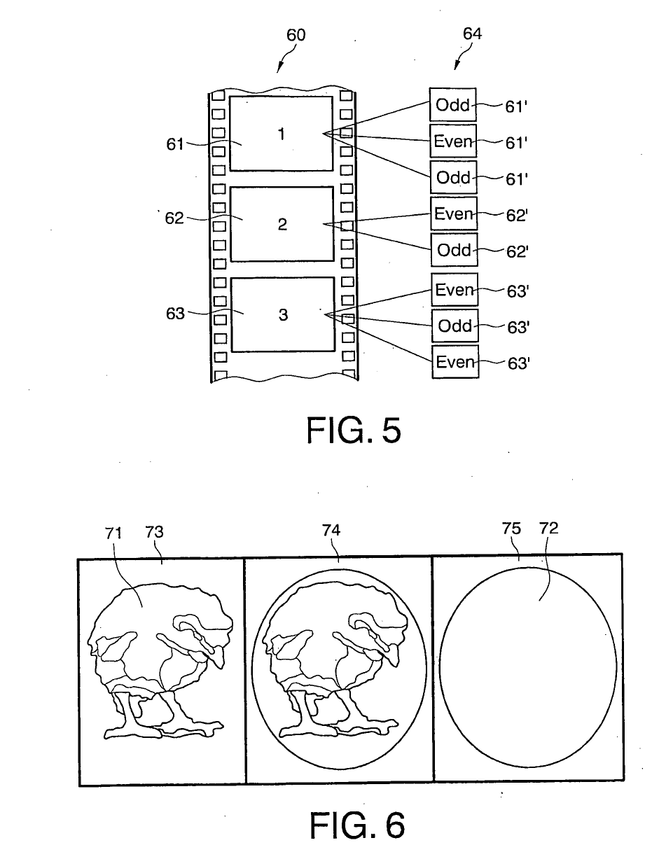

An exemplifying detailed description of a 3:2 PD processing may be taken from the disclosure of EP 1 215 900 A2. For the purpose of this application and in particular the next-generation system and the inventive concept, a 3:2 PD processing is to be understood as an operation that outputs successive movie frames as either three or two subsequent interlaced fields, which is further outlined with reference to FIG. 5. In this sense one field is to be understood as one half of a frame wherein the field has either an odd or an even scan line.

An exemplifying detailed description of an interpolation scheme acting on an already combined stream 111 of image fields may be taken from GB 22 49 907 A. For the purpose of this application and in particular the next-generation system and the inventive concept, any kind of pixel interpolation algorithm applied to a stream of image fields has to be understood as a motion compensated frame interpolation (FI) processing. In particular, a FI processing calculates a motion trajectory of moving picture elements. An advanced noise reduction, smooth motion reproduction, and improved sharpness and detail may be incorporated in a FI processing to provide a non-flickering picture of high quality. According to the implementation of an exemplary next-generation movie graphics system in FIG. 8, a first attempt to achieve judder compensation is provided by feeding a 24 fps output of a combining module into a 3:2 PD&FI processing module 127. The refresh rate of the stream 111 of a combined video image signal and graphics image signal is raised to an update rate of 60 fps of a display means 125. A converted stream 131 is provided on output line 129 to the display means 125.

In spite of the digital 3:2 PD&FI or equivalent processing in module 127, the animations shown on the output in form of the display means 125 according to the implementation 200 of the next-generation system still have judder artifacts that are noticeably larger than the judder artifacts of the underlying video image signal 103. Firstly this is because a motion blur often hides some of the judder in video image signals, whereas there is no motion blur in an animation bitmap of a graphics image signal. Secondly the digital FI or equivalent processing algorithm of module 127 is tuned to a video image signal and not to a bitmap animation content. As the stream 111 of image fields is combined from the video image signal 103 and graphics image signal 107, the implementation 200 of the next-generation system 100 cannot effectively prevent animation judder.

The invention has recognized that the problem of animation judder is specifically important for a next-generation combined graphics and further image signals format. Animation judder occurs in this and similar cases where a combined graphics and further image signal are converted into a predetermined reference refresh rate that is higher than the refresh rate of an input image signal.

### Description of the Preferred Inventive Embodiments

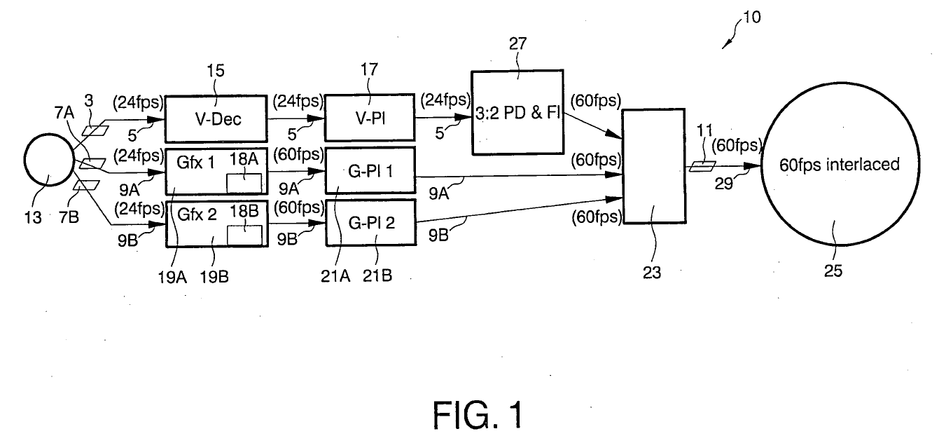

FIG. 1 shows a preferred embodiment of an image signal processing method 10 for providing a combined stream of image fields from a video image and graphics image signal. FIG. 1 can also be used to elucidate an image signal processing device 10 for providing a combined stream 11 of image fields. The preferred embodiment 10 to be described is particularly intended for an exemplary next-generation movie graphics format 100 and 200 as described with reference to FIG. 7 and FIG. 8, having a single video processing line 5 and two graphics processing lines 9A and 9B. However, it will be understood, that the invention is not limited thereto and that it can be readily adapted to work also within another movie graphics format, in particular having more or other processing lines compared with those shown in FIG. 1. It will be understood by those skilled in the art that any other number of processing lines, for example two, three, or more video processing lines and/or one, two, three, four, or more graphics processing lines, is available without departing from the spirit of the inventive concept.

Accordingly, the preferred embodiment of the method comprises the steps of:
providing image fields of a graphics image signal 7A, 7B at a graphics refresh rate in at least one graphics processing line 9A, 9B;

providing image fields of a video image signal 3 at a video refresh rate in at least one video processing line 5;

combining the video image signal 3 and the graphics image signal 7A, 7B into a combined stream of image fields.

The graphics refresh rate is the refresh rate of a graphics image signal 7A, 7B in the graphics processing lines 9A, 9B. The video refresh rate is the refresh rate of a video image signal 3 in the video processing line 5.

In the particular preferred embodiment of FIG. 1, the image signals 3, 7A, 7B are taken from a source 13 at an input refresh rate of 24 fps. The source 13 is realized as an optical storage device, e.g. an optical storage disc. According to the inventive concept and in contradistinction to the embodiments 100 and 200 shown in FIG. 7 and FIG. 8, the combining step is performed already at a predetermined reference refresh rate higher than the initial refresh rate of 24 fps of an input image signal 3, 7A, 7B. In the example of FIG. 1, the predetermined reference refresh rate is 60 fps, corresponding to the update rate of a display means 25 at the end of an output line 29. The combining step is performed by a combining module 23.

As a key issue of the inventive concept and in contradistinction to the embodiments 100 and 200 of FIG. 7 and FIG. 8, the graphics refresh rate is raised to the reference refresh rate before the combining step, i.e. by interpolating between the image fields of the graphics image signal 7A, 7B. An image signal processing device 10 comprises a drawing module 19A, 19B for this purpose in the at least one graphics processing line 9A, 9B for raising the graphics refresh rate of 24 fps to the reference refresh rate of 60 fps before the combining module 23. The drawing module 19A, 19B is formed as a graphics painter Gfx1 and Gfx2, respectively. The drawing module 19A, 19B comprises interpolation means 18A, 188B for interpolating between the image fields of the graphics image signal 9A, 9B.

In the preferred embodiment of FIG. 1, the raising step is formed by an initial drawing step in the at least one graphics processing line 9A, 9B, so the drawing module 19A, 19B is an initial module in processing line 9A, 9B, which receives the initial input graphics signals 7A, 7B of an input refresh rate. The drawing module 19A, 19B interpolates such that the graphics image signal 7A, 7B is outputted at a raised graphics refresh rate of 60 fps, which already corresponds to the reference refresh rate of 60 fps and also to an update rate of 60 fps of the display means 25.

The graphics image signal 7A, 7B is further processed along the two graphics processing lines 9A, 9B and is provided to a graphics plane 21A, 21B (G-P11, G-P12), respectively. This means that the graphics image signal 7A, 7B is delivered to the graphics plane 21A, 21B already at a refresh rate of 60 fps and is further provided to the combining module 23 at a refresh rate of 60 fps.

The video refresh rate, in contradistinction, is an initial input refresh rate of 24 fps of the input image signal 3. The input image signal 3 is provided by an initial video decoding step in the at least one video processing line 5. A video decoder 15 is arranged in the video processing line 5 for this purpose. Subsequently the video image signal 3 is provided by the video decoder 15 at the same refresh rate of 24 fps to a video plane (V-P1) 17 through video processing line 5. Accordingly, the video image signal 3 is provided to a video plane 17 at a refresh rate of 24 fps while the graphics image signal 7A, 7B is provided to a graphics plane 21A, 21B at a refresh rate of 60 fps which corresponds already to an update rate of a display means 25 and which exceeds the corresponding video refresh rate.

For the purpose of processing the video image signal 3 in the video processing line 5, the video refresh rate is subsequently raised to the reference refresh rate, again before the combing step, by 3:2 pull-down (PD) processing and/or motion compensated frame interpolation (FI) processing. Other kinds of natural motion (NM) processing of the video image signal fields may be applied as well. A 3:2 PD&FI processing is performed by a frame converter 27 arranged in the video processing line 5.

After the frame converter 27, the refresh rate of the video image signal 3 is raised to 60 fps corresponding to the update rate of the display means 25. Both the video image signal 3 and the graphics image signal 7A, 7B are thus provided at a same, predetermined reference refresh rate of 60 fps to the combining module 23 at this stage of processing. The combining step is performed in combining module 23 at the predetermined reference refresh rate corresponding to the update rate of the display means 25. The stream 11 of image fields from the video image signal 3 and graphics image signal 7A, 7B is also outputted at the predetermined reference refresh rate. Therefore, the stream 11 is readily suitable to be provided to the display 25 over output line 29 without further processing.

In summary, the image signal processing method and image signal processing device 10 as described with reference to FIG. 1 are capable of compensating judder, in particular animation judder, much more effectively than other systems thanks to the above-mentioned measures. The drawing modules, 19A, 19B are extended with an interpolation module 18A, 18B to make them draw graphics images, in particular animations such as moving objects and the like, at a predetermined refresh rate, in particular at a refresh rate corresponding to an update rate of a display means 25. In the example of FIG. 1, this refresh rate is 60 fps. Combining of the video image signal 3 and the graphics image signal 7A, 7B into a combined stream 11 of image fields from the video 3 and graphics image signal 7A, 7B is performed at a later stage of processing in combining module 23.

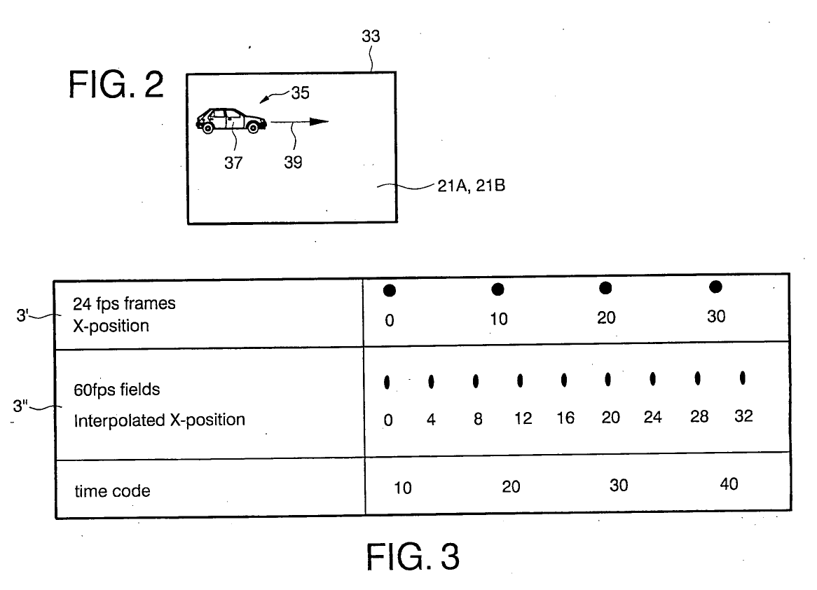

An example of a graphics plane 21A, 21B of FIG. 1 is shown in FIG. 2. The basic aspects of a preferred embodiment of an exemplary next-generation movie graphics system according to the inventive concept will now be described with reference to FIG. 2. FIG. 2 shows a drawing 33 of a graphics animation 35 in a graphics plane 21A, 21B as described with reference to FIG. 1. Moving objects 37 of an animation 35 on a screen are also referred to as “sprites” in the art. The exemplary next-generation movie graphics system foresees the possibility of graphics images in two graphics planes 21A, 21B, in particular animations 35, that are combined into a video image of a video image signal 3 in a combining module 23.

The animation 35 on each plane 21A, 21B is controlled by graphics data segments that are read from the source 13 and may be temporarily cached in a player RAM memory. The graphics data segments are usually combined with the audio/video data of a video image signal 3 into a single linear multiplexed stream 11. Such a multiplexed stream 11 may be stored on a disc or provided in an output line 29 to an output, e.g. a display means 25 as explained with reference to FIG. 1.

In general, two types of segments can be distinguished. Firstly, object definition segments, like one for the reference mark 37, may contain compressed bitmaps, e.g. a bitmap of a car. The bitmaps are decompressed and stored in the bitmap buffer in a player RAM. Secondly, composition segments serve to control the drawing 33, like the motion symbolized by arrow 39. A single segment describes a single static image on the screen at a particular time code. The situation is depicted in FIG. 2. The static image is represented by the object 37. A succession of segments, with their time codes at short intervals, can be used to create animation effects like a moving car. For example, a disc could contain the following composition segments 39 (in a simplified representation):
composition segment #1: at time code 10 show object 37 at (X, Y) position (0, 100)
composition segment #2: at time code 20 show object 37 at (X, Y) position (10, 100)
composition segment #3: at time code 30 show object 37 at (X, Y) position (20, 100)
composition segment #4: at time code 40 show object 37 at (X, Y) position (30, 100)

The object 37 in the form of a bitmap of a car is moved by the animation 35 in this example. It starts from the left of the graphics plane 21A, 21B or display means 25 and moves to the right.

According to the next-generation system, the time codes of the segments have to be aligned with a video field timing. Each time code needs to coincide with the exact presentation time code of a field in the video image signal 3, which is presented as a video stream of image fields on the video plane 17. A composition segment is not necessarily required for each field in the video—if there is no new segment, the most recent one keeps on being shown. A new composition segment is to be specified for each field in general in order to obtain smooth animations.

FIG. 3 shows an example of the interpolation means for interpolating between the image fields of a graphics image signal 7A, 7B. In the present example, the graphics refresh rate is raised to the reference refresh rate in the form of the update rate of a display means 25 by interpolation of known object positions in the image fields of a graphics image signal 7A, 7B at an input refresh rate of 24 fps. The input form 3′ of the video image signal 3 is shown in the first row of FIG. 3. Interpolated object positions in image fields of an interpolated graphics image signal 7A, 7B are provided at a predetermined reference refresh rate of 60 fps. This is the situation behind a drawing module 19A, 19B in the graphics processing line 9A, 9B. The interpolated form 3″ of the video image signal 3 is shown in the second row of FIG. 3. The last row of FIG. 3 indicates the time code.

One of ordinary skill in the art will recognize that many interpolation methods, i.e. filling in missing points on a curve that goes through known points, are known in the art. Depending on the application, interpolation schemes like linear interpolation, a polynomial interpolation, or a spline interpolation and the like may be used to interpolate between the image fields of the graphics image signal.

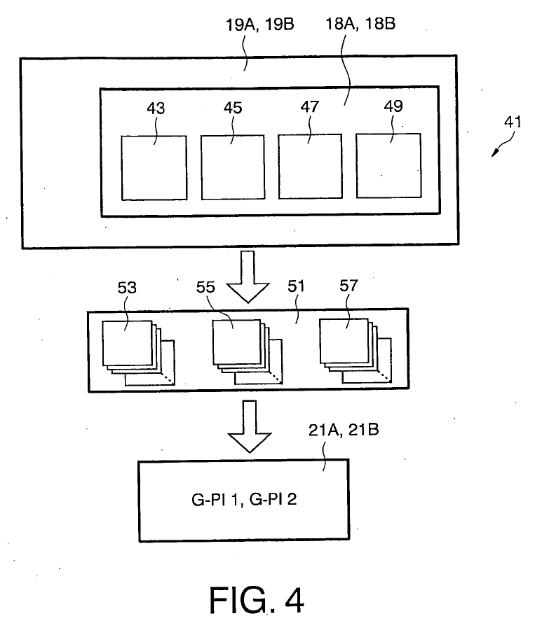

A particular preferred developed modification of the interpolating means 18A, 18B of FIG. 1 is described with reference to FIG. 4. FIG. 4 is a diagram of implementation of the interpolating means 18A, 18B in a drawing module 19A, 19B for raising the graphics refresh rate to the reference refresh rate. The elements of the raising step are indicated by reference numeral 41. The interpolating means 18A, 18B comprise further modules 43, 45, 47, 49 for further tailoring of the interpolating step. The drawing module 19A, 19B acts on the graphics data segments 51 as shown by the flow line of arrows. It is indicated above the graphics that data segments 51 comprise object definition segments 53, composition segments 55, and color look-up-table segments 57, which are described in the following. An interpolating step 41 in particular affects the position of a graphics object, thereby providing a 60 fps refresh rate graphics image signal to the graphics plane 21A, 21B.

In a developed modification of the preferred embodiment, the image signal processing method is further characterized in that:
an animation graphics of a graphics image signal 7A, 7B is at least based on one or more object definition segments 53 and/or one or more composition segments 55 and/or one or more color look-up-table control segments 57; wherein
the step of interpolation comprises motion interpolation for objects 37 of the animation graphics 35.

A motion 39 of an object 37 is characterized as a tailoring measure 43, whereupon a decision is outputted whether or not to apply a motion interpolation like e.g. the one of FIG. 3. In other words, the means for interpolating comprise a characterizing and/or decision module 43 for deciding whether motion interpolation between some segments should be used at all. The decision can be made on an object by object basis. The reason for this characterizing and/or decision module 43 is that in general it is not mandatory to have a composition segment 55 for each subsequent field as indicated in FIG. 3. In some cases, the next-generation movie graphics system standard will even force the omission of some otherwise desired segments, because including them would create a graphics drawing workload exceeding the resources of the reference drawing engines specified by the standard. The means for interpolating will therefore have to take some measures to interpolate over a distance greater than one field or frame. On the other hand, if the distance between two composition segments is very great, a disc author may have intended a “jumping” motion of an object rather than a smooth motion. To discriminate between the latter situation and the former situation, a decision module comprises certain means for characterizing a motion and for deciding, in particular on an object by object basis, whether motion interpolation between some segments should be used at all.

A further developed modification of the preferred embodiment is characterized in that the interpolating step comprises one or more of the measures 45 selected from the group consisting of:
adjusting a trajectory 39 of an object 37 such that an overlap with another object is prevented;
disabling parts of an object 37 that overlap another object;
prohibiting an overlap of an object 37 with another object, except for transparent pixels.

The tailoring measure recognizes that in the next-generation system more than one object 37 can move on the screen at once. Nevertheless, no overlapping of objects is allowed, since computing time will be kept advantageously low by such a measure. In a specific example, all objects have rectangular bitmaps (for a non-rectangular object some pixels are transparent), and the rectangular bitmaps of the objects must never overlap in the drawing instructions specified by a composition segment 55. This rule makes drawing operations easier to implement and less resource intensive. It may be that, when interpolation is done between composition segments 55, some bitmaps nevertheless do overlap, which in general could be a problem for the process of drawing provided in the drawing module 19A, 19B. In a developed modification of the preferred embodiment, the above measures are provided in a never-overlap-module 45 and serve to detect and/or fix an overlap of objects 37.

In still a further developed modification of the preferred embodiment, the interpolating step comprises one or more of the measures 47 selected from the group consisting of:
detecting objects of subsequent composition segments 55 having object positions which are comparably close to each other,
detecting objects of comparable size and/or comparable number of non-transparent pixels,
detecting composition segments 55 comprising multiple objects of matching order.

Such measures are preferably provided in an extra module 47, which is specifically adapted to detect same objects of same measure and of multiple cyclically appearance. To give a detailed explanation of this further tailoring measure, an object 37 in FIG. 2 contains a bitmap of a car and moves (Ref. 39) over a graphics plane 21A, 21B. A more complicated example is to make an animation, e.g. containing the movement in which a man walks over the graphics plane 21A, 21B. In the latter situation multiple objects, like a leg or an arm, are shown cyclically, each object with a bitmap that show the man's legs or arms in different positions. This implies additional difficulties for the interpolation because the object number may change for different segments 53, 55. For example:
composition segment #151: at time code 110 show object 3 at (X, Y) position (0, 100)
composition segment #152: at time code 120 show object 3 at (X, Y) position (10, 100)
composition segment #153: at time code 130 show object 4 at (X, Y) position (20, 100)
composition segment #154: at time code 140 show object 4 at (X, Y) position (30, 100)
composition segment #155: at time code 150 show object 5 at (X, Y) position (40, 100)
composition segment #156: at time code 160 show object 5 at (X, Y) position (50, 100)

Consequently the cyclical object definition module 47 implies some useful algorithms for processing the method steps as listed above and is provided in the interpolation means 18A, 18B for deciding e.g. that the object numbers 3 and 4 indicated above are really the same meta-object, so that interpolation, e.g. between the segment numbers #152 and #153, is possible.

A further tailoring measure 49 takes into account that a next-generation movie graphics system standard may allow the use of color look-up-tables (CLUTs) as part of its graphics subsystem. The content author may in this case have the ability to change the contents of the color look-up-table rapidly (e.g. once for every frame at the graphics frame rate) by adding color look-up-table control segments 57 to the authored multiplex stream. In this case, the author can use a so-called “color cycling” technique to achieve movement effects. Color cycling is a technique by which rapid changes to the CLUT are combined with specially tailored bitmap graphics contents on the screen. Color cycling is the process of rapidly changing an object's colors to achieve the illusion of a smooth movement. It is often used in games to animate waterfalls, lava, or torches in a cyclical manner. The advantage of color cycling is that an impression of motion can be achieved simply by changing the colors in a logical palette. Once an object itself has been drawn, the pixels comprised in the object are not modified except for their color. Using color cycling, a content author can achieve an effect where an object 37 visually moves at a relatively high frame rate (typically at the graphics frame rate), while the underlying bitmap picture only moves at a relatively low frame rate (typically ½ or ⅓ of the graphics frame rate). Color cycling can be attractive if the format restricts the rate at which a bitmap can be moved. This is particularly advantageous for large bitmaps. The use of color cycling presents a particular preferred extra issue for the proposed inventive concept, because it depends on interpolating between bitmap positions. If color cycling is used, the bitmap motion interpolation process carried out to raise the graphics frame rate to the reference frame rate can be altered accordingly to take into account the extra motion effects due to the color cycling.

In a yet further developed modification of the preferred embodiment, the interpolating step comprises one or more of the measures 49 selected from the group consisting of:
detecting a color look-up-table manipulation strategy; in particular this comprises detecting the use of a color cycling technique by the author in the multiplexed stream, preferably by detecting the presence of one or more, in particular many, color look-up-table (CLUT) control segments 57, and/or by analyzing the contents of such segments 57.
analyzing a color look-up-table (CLUT) control segment 57 and/or an object definition segment 53; this is done in particular by doing a cross-analysis of one or more color look-up-table (CLUT) control segments 57 and in particular the bitmaps in one or more object definition segments 53. It is determined thereby for which objects 37 the content author is using a color cycling technique.
disabling or modifying an interpolation means 18A, 18B for motion interpolating the motion 39 of one or more objects 37 in the animation graphics (35). As a result, the interpolation process can be at least advantageously modified when color cycling is detected.

Accordingly, such measures are preferably provided in an extra CLUT-detection module 49, which is specifically adapted for suppressing interpolation if certain CLUT-manipulation strategies are detected. The module 49 implies some useful algorithms to process the method steps as listed above and is provided in the interpolation means 18A, 18B.

In a first refinement of the preferred embodiment, a switch may be added that can toggle between the use of an image signal processing method/device 10 as shown in FIG. 1 and an image signal processing method/device 200 as shown in FIG. 8. Such a switch is preferably dynamically adjustable in accordance with the anticipated graphics drawing workload. If the workload is too high to be realized with the method/device 10 of FIG. 1, the lower-quality method/device 200 of FIG. 8 can be used. The anticipation of the graphics workload is preferably based on looking ahead at future composition segments. This refinement is based on the recognition that the method/device 10 of FIG. 1 provides a stream of combined image fields from the video and graphics image signal at a refresh rate of 60 fps. This kind of processing therefore consumes more system resources than the implementation of the method/device 200 of FIG. 8. In situations where the workload is critical due to the 60 fps refresh rate processing, the prior art implementation of FIG. 8 is preferably used.

In a second refinement, a specific processing algorithm may be used to add a motion blur to a graphics object, like an object 37 shown in FIG. 2. A motion blur is naturally present in a video image signal, but not in a graphics image signal. A motion blur can be gradually provided in a graphics image signal to hide an animation judder, thus providing a further tool to make an animation judder compensation even more effective.

A developed modification of the frame converter 27 of FIG. 1 is described with reference to FIG. 5. FIG. 5 shows a film 60 and several film frames 61, 62, 63, each showing a respective number 1, 2, 3. The fields of an original film or movie are usually referred to as frames. A 3:2 pull-down processing as known, for example, from EP 1 215 900 A2 is demonstrated in a simplified scheme in FIG. 5. Within the context of the present application, a 3:2 pull-down processing has to be understood as an operation that outputs successive movie frames 61, 62, 63 as either three or two subsequent interlaced fields 61′, 62′, 63′, forming a stream 64 of interlaced video fields. Such a stream 64 is generally contained in a video image signal 3 of FIG. 1. The interlaced video fields referring to the same frame (e.g. frame 61 and interlaced fields 61′, or frame 62 and interlaced fields 62′, or frame 63 and interlaced fields 63′) are distinguished as being odd and even fields. A simple 3:2 pull-down processing as described above raises the refresh rate of a video stream 64 to that of a film 60 and helps to reduce (OK?), but can not reliably prevent, judder artifacts. In particular, the effect of a judder artifact becomes more obvious when the frame rate conversion is made by simple deletions or repetitions of selected frames or fields. It may become less obvious when interpolated frames or fields are generated by the use of predictive algorithms. These and other kind of measures may be implied in a frame converter 27 of FIG. 1.

Particular preferred developed modifications of the combining module 23 of FIG. 1 are described with reference to FIG. 6. FIG. 6 demonstrates a preferred kind of combining step processing, which is herein referred to as alpha-blending. A combining module 23 as described with reference to FIG. 1 is preferably formed as an alpha-blend module. Alpha-blending is used in computer graphics to create the effect of transparency. This is achieved by combining a translucent foreground with a background color to create an in-between blend. For animations and other kinds of graphics image signals, and also for combining a video image signal and a graphics image signal, alpha-blending is applied to the subject matter of this application to create the appearance of semi-transparent overlays (e.g. a semi-transparent button on top of a playing video) and also to gradually fade one image 71 into another image 72.

An image conventionally uses four channels to define its color in computer graphics with alpha-blending. Three of these are the primary color channels—red, green and blue. The fourth, known as the alpha-channel, conveys information about the image's transparency. It specifies how foreground colors should be merged with those in the background when overlaid on top of each other. In a simplified form, the equation used in alpha-blending is: [r,g,b]_{blended}=α[r,g,b]_{foreground}+(1−α)[r,g,b]_{background}; where “[r,g,b]” represents the red, green, blue color channels and “ ” represents a weighting factor. The weighting factor may take any value from 0 to 1. When it is set to 0, the foreground is completely transparent as shown in section 73 of FIG. 6. When the α-factor is set to 1, it becomes opaque and totally obscures the background, which is shown in section 75 in FIG. 6. Any intermediate value creates a mixture of the two images as shown e.g. for an α-factor of 0.5 in section 74 of FIG. 6.

In summary, conventional concepts of signal processing have no specifically adapted judder compensation for combined streams of fields from graphics and further image signals and therefore show animation judder artifacts. Judder compensation is presently adapted for further image signals like video only, and motion blur in a video image signal often hides judder artifacts. However, this is not the case for graphics objects like bitmaps. At an increased reference refresh rate (60 fps) the inventive concept provides a combined stream 11 of fields of the further 3 and the graphics 7A, 7B image signals, in particular comprising animations 35. Interpolation 18A, 18B between the image fields of the graphics image signal 7A, 7B as early as during the creation of the graphics image signal 7A, 7B raises the input refresh rate (24 fps) of a graphics image signal 7A, 7B to the reference refresh rate (60 fps) already before the combining step 23. A fairly simple interpolation method and developed configurations thereof achieve a high-quality output on a display 25, superior to that of sophisticated state of the art systems.

### REFERENCE NUMERALS

3 video image signal
5 single processing video processing line
7A, 7B graphics image signal
9A, 9B graphics processing line
10 image signal processing method/device
13 source
15 video decoder
18A, 18B interpolation means
19A, 19B drawing module
21A, 21B graphics plane
23 combining module
25 display means
27 frame converter
33 drawing
35 animation graphics
37 object
39 motion
41 raising step
43 characterizing and decision module/means
45 never-overlap module/means
47 cyclically object definition module/means
49 CLUT detection module/means
51 data segments
53 object definition segments
55 composition segments
57 CLUT control segments
60 film
61, 62, 63 frame
61′, 62′, 63′ interlaced field
64 stream of fields
71, 72 image
73, 74, 75 section
100 next-generation movie graphics system standard
103 video image signal
105 video processing line
107 graphics image signal
109 graphics processing line
111 stream
113 source
115 video decoder
117 video plane
119 drawing module
121 graphics plane
123 combining module
125 display means
127 processing module
129 output line
131 converted stream
200 implementation of a next-generation movie graphics system
Gfx1, Gfx2 initial graphics image drawing step
FI frame interpolation processing
PD pulldown processing

1-26. (canceled)

27. An image signal processing method (10) for providing a combined stream (11) of image fields from a graphics image signal and a further image signal, the method comprising the steps of:
providing image fields of the graphics image signal (7A, 7B) at a graphics refresh rate in at least one graphics processing line (9A, 9B);
providing image fields of the further image signal (3) at a further refresh rate in at least one further processing line (5);
raising (41) the graphics refresh rate of the graphics image signal (7A, 7B) to a reference refresh rate by interpolating between the image fields of the graphics image signal (7A, 7B);
raising (27) the further refresh rate of the further image signal (3) to the reference refresh rate by interpolating between the image fields of the further image signal (3); and
combining (23) the further image signal at the reference refresh rate and the graphics image signal at the reference refresh rate into a combined stream (11) of image fields at the reference refresh rate.

28. The method as claimed in claim 27, characterized in that the raising step (41) is performed by means of an initial graphics image drawing step (Gfx1, Gfx2) for interpolating the original image frames of the graphics image signal (7A, 7B).

29. The method as claimed in claim 28, characterized in that a graphics refresh rate in the at least one graphics processing line (9A, 9B) is higher than the further refresh rate in the at least one further processing line (5).

30. The method as claimed in claim 29, characterized in that a further refresh rate is equal to an input refresh rate of the further image signal (3) provided by an initial video decoding step (V-Dec) in the at least one further processing line (5).

31. The method as claimed in claim 27, characterized in that the further refresh rate is raised to the reference refresh rate by means of 3:2 pull-down processing (PD) and/or frame interpolation processing (FI) of the further image signal fields.

32. The method as claimed in claim 27, characterized in that the reference refresh rate is predetermined by and equal to an update rate of a display means (25).

33. The method as claimed in claim 27, characterized in that the stream of image fields from the further image signal (3) and the graphics image signal (7A, 7B) is provided on the basis of an optical storage format.

34. The method as claimed in claim 27, characterized in that the further image signal is formed by a video image signal (3), the further refresh rate is formed by a video refresh rate, and the further processing line is formed by a video processing line (5).

35. The method as claimed in claim 27, characterized in that
the graphics image signal (7A, 7B) comprises an animation graphics (35) having an object (37) and a motion (39) and being at least based on one or more object definition segments (53) and/or one or more composition segments (55) and/or one or more color look-up-table control segments (57); wherein
the raising step (41) comprises an interpolation means (18A, 18B) for motion interpolating the motion (39) of the object (37) in the animation graphics (35).

36. The method as claimed in claim 35, characterized in that the interpolation means (18A, 18B) comprises (43) a motion (39) of an object (37), whereupon a decision is outputted whether or not to apply the motion interpolation.

37. The method as claimed in claim 35, characterized in that the interpolation means (18A, 18B) comprises one or more measures (45) selected from the group consisting of:
adjusting a motion (39) of an object (37) such that an overlap with another object is prevented;
disabling parts of an object (37) that overlap another object;
prohibiting an overlap of an object (37) with another object, except for transparent pixels.

38. The method as claimed in claim 35, characterized in that the interpolation means (18A, 18B) comprises one or more measures (47) selected from the group consisting of:
detecting objects of subsequent composition segments (55) having object positions which are comparably close to each other;
detecting objects of comparable size and/or comparable number of non-transparent pixels;
detecting composition segments (55) comprising multiple objects which are listed in matching order.

39. The method as claimed in claim 35, characterized in that the interpolation means (18A, 18B) comprises one or more measures (49) selected from the group consisting of:
detecting a color look-up-table manipulation;
analyzing a color look-up-table control segment (57) and/or an object definition segment (53);
disabling or modifying an interpolation means (18A, 18B) for motion interpolating the motion (39) of one or more objects (37) in the animation graphics (35).

40. An image signal processing device (10) for providing a combined stream (11) of image fields from a graphics image signal and a further image signal, the device comprising:
at least one graphics processing line (9A, 9B) for providing image fields of a graphics image signal (7A, 7B) at a graphics refresh rate;
at least one further processing line (5) for providing image fields of a further image signal (3) at a further refresh rate;
a drawing module (19A, 19B) in the at least one graphics processing line (9A, 9B) comprising interpolation means (18A, 18B) for interpolating between the image fields of the graphics image signal (7A, 7B) for raising the graphics refresh rate to a reference refresh rate upstream of a combining module (23);
a frame converter (27) in the at least one further processing line (5) for interpolating between the image fields of the further image signal (3) for raising the further refresh rate to the reference refresh rate; and
the combining module (23) for combining the further image signal at the reference refresh rate and the graphics image signal at the reference refresh rate into a combined stream (11) of image fields at the reference refresh rate.

41. The device as claimed in claim 40, further comprising:
a decoder (15) in the at least one further processing line (5) for providing a further image signal (3) at a further refresh rate equal to an input refresh rate of the further image signal (3).

42. The device as claimed in claim 40, wherein the frame converter (27) is arranged to raise the further refresh rate to the reference refresh rate upstream of the combining module (23) by means of a 3:2 pull-down processing module and/or a frame interpolation processing module (3:2 PD&FI).

43. The device as claimed in claim 40, wherein the combining module (23) is formed by an alpha-blend module.

44. The device as claimed in claim 40 in the form of an optical playback device.

45. An apparatus for image signal processing, comprising an image signal processing device as claimed in claim 40, an image storage device (13), and/or a display means (25).

46. The apparatus as claimed in claim 45, characterized in that the image storage device (13) is formed by an optical storage device, in particular in the form of an optical storage disc.

47. The apparatus as claimed in claim 45, characterized in that the display means (25) is selected from the group consisting of: Cathode Ray Tubes (CRT), Liquid Crystal Displays (LCD), and Plasma Display Panels (PDP).

48. An apparatus comprising an image signal processing device, wherein the image signal processing device is adapted to perform the method of claim 27.

49. A computer program product storable on a medium readable by a computing device comprising a software code section which induces the computing device to execute the method of claim 27 when the product is executed on the computing device.

50. A computing and/or storage device for executing and/or storing the computer program product as claimed in claim 49.
